(19) United States
(12) Patent Application Publication
(10) Pub. No.: US 2010/0127946 A1
(43) Pub. Date: May 27, 2010

(54) Adjusting Apparatus for Satellite Antenna

(76) Inventor: Kang Hsi TUNG, Tantih Township (TW)

Correspondence Address: HDLS Patent & Trademark Services, P.O. BOX 220746, CHANTILLY, VA, 20153-0746, US

(21) Appl. No.: 12/323,102

(22) Filed: Nov. 25, 2008

(51) Int. Cl. H01Q 3/00

(52) U.S. Cl. 343/763

(57) ABSTRACT

An adjusting apparatus for a satellite antenna of accurate and superfine adjustment and simple structure, includes a dish support, a supporting base, a connecting base, an X-direction fine adjusting mechanism and a Y-direction fine adjusting mechanism. The dish support couples to a dish of the satellite antenna. The supporting base couples to the antenna support. The connecting base connects between the dish support and the supporting base. The X-direction fine adjusting mechanism couples between the supporting base and the connecting base. The Y-direction fine adjusting mechanism couples between the connecting base and the dish support. The X-direction and Y-direction fine adjusting mechanisms respectively by means of the meshing relation between the gear and the row teeth to fine adjust, inducing the satellite antenna, relative to the antenna support, generate tiny range of motions along X and Y directions, respectively.

### BACKGROUND

1. Field of the Invention

The present invention relates to pedestals for adjusting satellite antennas, and more particularly, to an adjusting apparatus for a satellite antenna, capable of fine adjusting horizontal and perpendicular orientations of the satellite antenna accurately.

2. Description of the Related Art

Referring to the use of the satellite antennas, such as bow-tie antennas, for obtain better receiving angles, a conventional way is to dispose an adjusting pedestal, capable of adjusting angles, between the dish body of the satellite antenna and an antenna support. The adjusting pedestal provides adjusting operations along X and Y directions, by the adjustment allocation along X and Y directions, obtaining the most suited receiving angle, so that the electronic apparatus can obtain the clear and impurity-free signal receiving effect.

The angle adjusting mechanisms of the conventional adjusting pedestals for the satellite antennas ordinarily use hole-to-hole manner, or single-to-elongate hole-to-hole manner for contraposition, in order to obtain the adjustment effect for the fixing range. However, the hole-to-hole manner could not obtain the accurate fine adjustment effect because of its large band range. The single-to-elongate hole-to-hole manner merely adjusts by the operation experience and is difficult to operate. Moreover, after the adjustment, the screw is needed to lock up, for obtaining the final adjusting position. Thus, in the adjustment process, the no-band elongate-hole can not be positioned immediately, therefore, in the process of locking the screw, the pre displaced adjustment range is easily be influenced and further loses the accurate adjustment effect.

From the above descriptions, the existed holes alignment adjusting structure, not only is difficult to operate, and of complicated components, but also is not accurate enough, and not polish in use, and can merely serve as a coarse adjustment manner, therefore, searching for the solution is necessarily.

### BRIEF SUMMARY

The present invention provides an adjusting apparatus for a satellite antenna, by means of the meshing relation between the gear and the row teeth, the satellite antenna can, relative to the antenna support, obtain the accurate and inerrant fine adjustment effect along the horizontal and perpendicular directions, and the adjusting apparatus is easy to operate and is of the simple structure.

The adjusting apparatus for a satellite antenna of the present invention, for connecting between a satellite antenna and an antenna support, comprises a dish support for coupling to a dish of the satellite antenna; a supporting base coupled to the antenna support; a connecting base connected between the dish support and the supporting base; an X-direction fine adjusting mechanism comprising at least a group composed by a gear and a row teeth, and being coupled between the supporting base and the connecting base, by means of the meshing relation between the gear and the row teeth, connecting the dish support, inducing the satellite antenna, relative to the antenna support, generate a tiny range of motions along X-direction; and a Y-direction fine adjusting mechanism comprising at least a group composed by a gear and a row teeth, and being coupled between the connecting base and the dish support, by means of the meshing relation between the gear and the row teeth, connecting the connecting base and the dish support, inducing the satellite antenna, relative to the antenna support, generate a tiny range of motions along Y-direction.

The dish support includes a bottom bracket, a clawed fixing bracket and a coupling bracket, the fixing bracket being coupled to the dish of the satellite antenna, the bottom bracket outwardly extending from the fixing bracket, inducing the peripheral fringe of the satellite antenna abut against the bottom bracket, the coupling bracket extending from the fixing bracket toward a direction remote from the dish of the satellite antenna; the supporting base including a supporting dish and a socket pipe, the socket pipe being connected to the antenna support, the supporting dish being arranged on the socket pipe; the connecting base including a bottom wall and two sidewalls; the X-direction fine adjusting mechanism including a first gear and a first row teeth meshed with the first gear, the first gear being pivoted on the supporting dish of the supporting base, the first row teeth being disposed on the side end surface of the bottom wall of the connecting base; the Y-direction fine adjusting mechanism including a second gear and a second row teeth meshed with the second gear, the second gear being pivoted on the coupling bracket of the dish support, the second row teeth being disposed on the side end surface of the sidewall of the connecting base.

The first row teeth is in an arc shape, the supporting dish of the supporting base having an arced elongate slot, the elongate slot being configured to match the curve of the first row teeth.

The second row teeth is in an arc shape, the coupling bracket of the dish support having an arced elongate slot, the elongate slot being configured to match the curve of the second row teeth.

The dish support includes a main base and a plurality of lugs, the lugs being locked to the dish of the satellite antenna, the supporting base including a bottom wall, two sidewalls, an indent portion, and at least a fine adjusting hole disposed on at least one of the sidewalls, the indent portion being clasped and abutting on the antenna support; the connecting base including a bottom wall, two sidewalls, an inner lining plate, an outer lining plate, and at least an adjusting hole disposed on at least one of the sidewalls; the X-direction fine adjusting mechanism including a first gear and a first row teeth meshed with the first gear, the first row teeth being disposed at the periphery of the fine adjusting hole of the supporting base, the first gear being received in the fine adjusting hole and pivoted on the outer lining plate of the connecting base; the Y-direction fine adjusting mechanism including a second gear and a second row teeth meshed with the second gear, the second row teeth being disposed at the periphery of the adjusting hole of the connecting base, the second gear being received in the adjusting hole and pivoted on the inner lining plate of the connecting base.

The first row teeth is in an arc shape, the sidewall of the supporting base having an arced elongate slot, the outer lining plate of the connecting base having a locking hole corresponding to the elongate slot, and being locked to the connecting base, the elongate slot being configured to match the curve of the first row teeth.

The second row teeth is in an arc shape, the sidewall of the connecting base having an arced elongate slot, the inner lining plate of the connecting base having a locking hole corresponding to the elongate slot, and being locked to the dish support, the elongate slot and the locking hole being configured to match the curve of the second row teeth.

The present invention by means of the meshing relation between the gear and the row teeth, induces both of the orientation adjustments along X and Y directions can obtain the accurate fine adjustment effect, and furthermore, the adjusting apparatus is of simple structure and is easy and rapid to operate.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an isometric view of the first embodiment of the present adjusting apparatus for the satellite antenna;

FIG. 2 is another isometric view of the adjusting apparatus for the satellite antenna of the first embodiment;

FIG. 3 is a side view of an assembly, showing the adjusting apparatus is assembled to the satellite antenna and the antenna support;

FIG. 4 is a rear view of the assembly, showing the adjusting apparatus is assembled to the satellite antenna and the antenna support;

FIG. 5 is an enlarged view in partial section of FIG. 4;

FIG. 6 is a top, assembled view of the second embodiment of the present adjusting apparatus for the satellite antenna;

FIG. 7 is an enlarged view in partial section of FIG. 6; and

FIG. 8 is a top, assembled view of the adjusting apparatus for the satellite antenna of the second embodiment.

### DETAILED DESCRIPTION

The present adjusting apparatus for the satellite antenna has the following functions: by means of the meshing relation between the gear and the row teeth, obtaining the accurate fine adjusting effect, and the adjusting apparatus is of the simple structure and easy to operate.

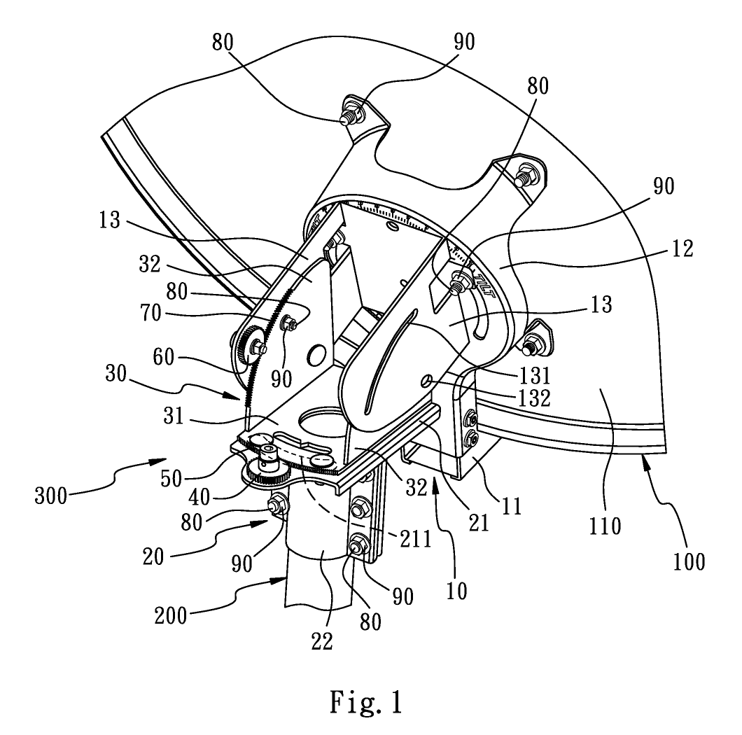

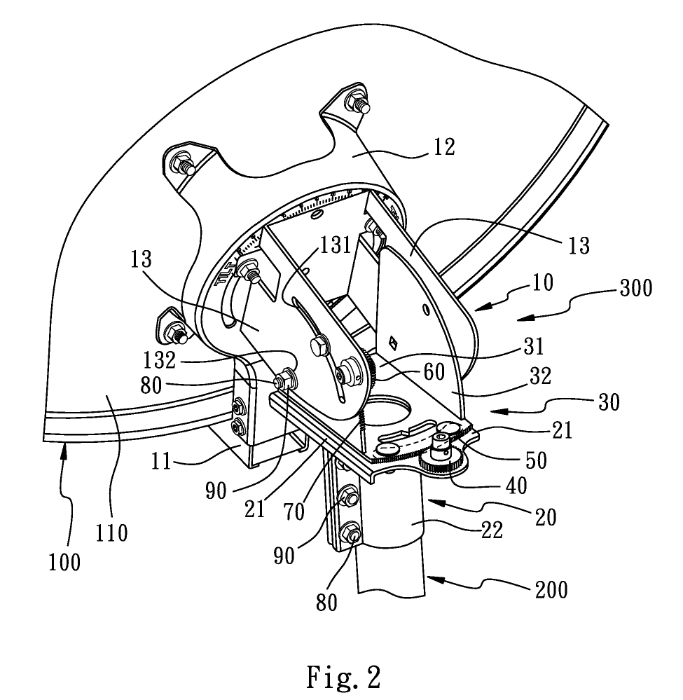

Referring to FIGS. 1 and 2, a first embodiment of the present adjusting apparatus for the satellite antenna is for connecting between a satellite antenna 100 and an antenna support 200. The adjusting apparatus 300 includes a dish support 10, a supporting base 20, a connecting base 30, a first gear 40, a first row teeth 50, a second gear 60, a second row teeth 70, a plurality of screw bolts 80 and a plurality of screw caps 90.

The dish support 10 is for coupling to a dish 110 of the satellite antenna 100. The dish support 10 includes a bottom bracket 11, a clawed fixing bracket 12 and a coupling bracket 13. The fixing bracket 12 is locked to the dish 110 of the satellite antenna 100 by the screw bolts 80 and the screw caps 90. The bottom bracket 11 outwardly extends from the fixing bracket 12, inducing the peripheral fringe of the satellite antenna 100 abut against the bottom bracket 11. The coupling bracket 13 extends from the fixing bracket 12 toward a direction remote from the dish 110 of the satellite antenna 100. The coupling bracket 13 is an n-shaped bracket, and is fixed to the rear side of the fixing bracket 12 by the screw bolts 80 and the screw caps 90. Two sidewalls of the coupling bracket 12 each define an arced elongate slot 131 and a locking hole 132.

The supporting base 20 is coupled to the antenna support 200. The supporting base 20 includes a supporting dish 21 and a socket pipe 22. The socket pipe 22 is locked to the antenna support 200 by the screw bolts 80 and the screw caps 90. The supporting dish 21 is horizontally arranged on the socket pipe 22.

The connecting base 30 is connected between the dish support 10 and the supporting base 20. The connecting base 30 includes a bottom wall 31 and two sidewalls 32. Both of the sidewalls 32 are sector plates.

The first gear 40 and the first row teeth 50 cooperatively compose of the fine adjusting mechanism along X-direction, and are coupled between the supporting base 20 and the connecting base 30. The first gear 40 is pivoted on the supporting dish 21 of the supporting base 20, while the first row teeth 50 is disposed on the side end surface of the bottom wall 31 of the connecting base 30.

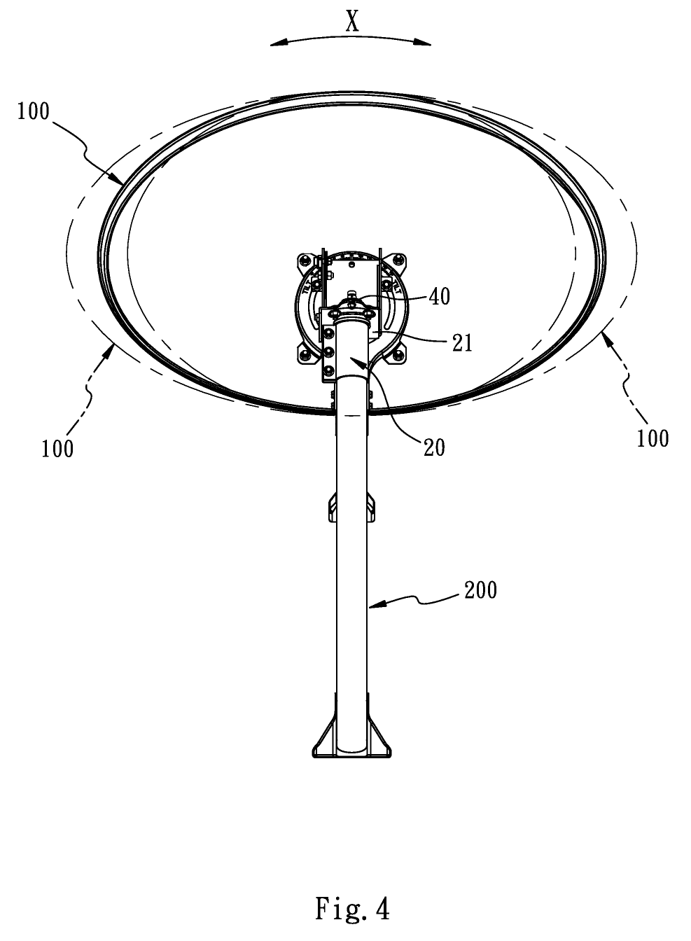

Referring to FIGS. 1, 4 and 5, the first row teeth 50 is in an arc shape, the supporting dish 21 of the supporting base 20 has an arced elongate slot 211, the elongate slot 211 is configured to match the curve of the first row teeth 50. A group of screw bolts 80 and screw caps 90 are disposed through the bottom wall 31 of the connecting base 30 and the supporting dish 21, and the screw bolts 80 just locates in the elongate slot 211. By means of the meshing relation between the first gear 40 and the first row teeth 50, indirectly connecting the dish support 10, so that the satellite antenna 100, relative to the antenna support 200, generates a tiny range of motions along X-direction. Referring to the arrow X of FIG. 4, the satellite antenna 100 indicated by the imaginary line are capable of pivot to left or to right, further obtains the fine adjustment effect along X-direction, after the adjustment the connecting base 30 are locked together with the supporting base 20 by the screw bolts 80 and the screw caps 90.

The second gear 60 and the second row teeth 70 cooperatively compose of the fine adjusting mechanism along Y-direction, and are coupled between the dish support 10 and the connecting base 30. The second gear 60 is pivoted on the coupling bracket 13 of the dish support 10, while the second row teeth 70 is disposed on the end surface of the sector sidewall of the connecting base 30.

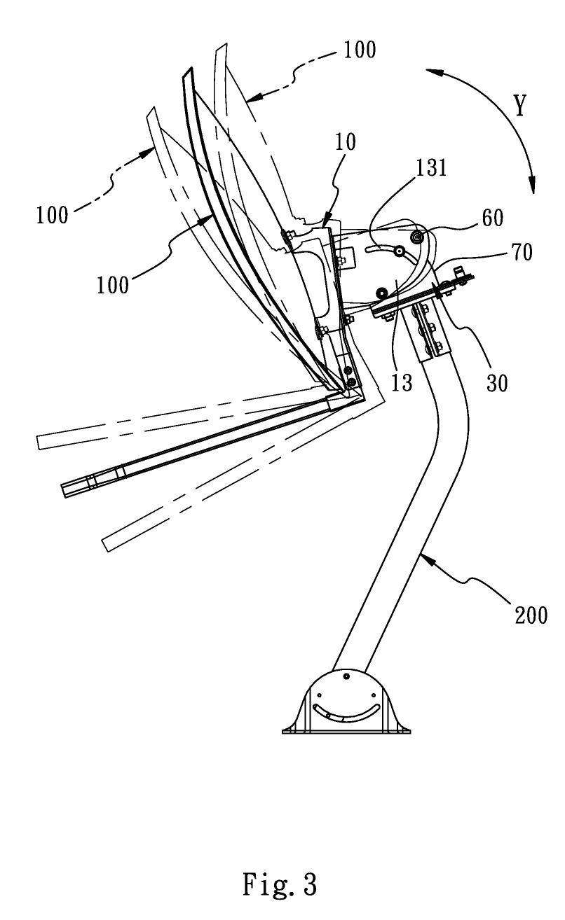

Cooperatively referring to FIG. 3, the second row teeth 70 is in an arc shape, the curve of the second row teeth 70 is configured to match the configuration of the elongate slot 131 of the coupling bracket 13 of the dish support 10. A group of screw bolts 80 and screw caps 90 are disposed through the coupling bracket 13 and the sidewalls 32 of the connecting base 30, and the screw bolts 80 just locates in the elongate slot 131 of the coupling bracket 13. By means of the meshing relation between the second gear 60 and the second row teeth 70, connecting the connecting base 30 and the dish support 10, so that the satellite antenna 100, relative to the antenna support 200, generates a tiny range of motions along Y-direction. Referring to the arrow Y in FIG. 3, the satellite antenna 100 indicated by the imaginary line are capable of pivot upwardly or downwardly, further obtains the fine adjustment effect along Y-direction, after the adjustment the connecting base 30 are locked together with the dish support 10 by the screw bolts 80 and the screw caps 90.

From the above descriptions, in the present adjusting apparatus for the satellite antenna, the adjustment manner of the gear and the row teeth cooperating with the elongate slot to operate synchronous adjustment, not only brings the satellite antenna 100 have the left and right offset adjustments and the upside and downside elevation adjustments, but also by means of the meshing relation between the gear and the row teeth, inducing the adjustment range be more superfine and accurate, therefore obtaining the accurate fine adjustment effect. Furthermore, the adjusting apparatus 300 is of simple structure and easy to operate, and is conduced to be assembled.

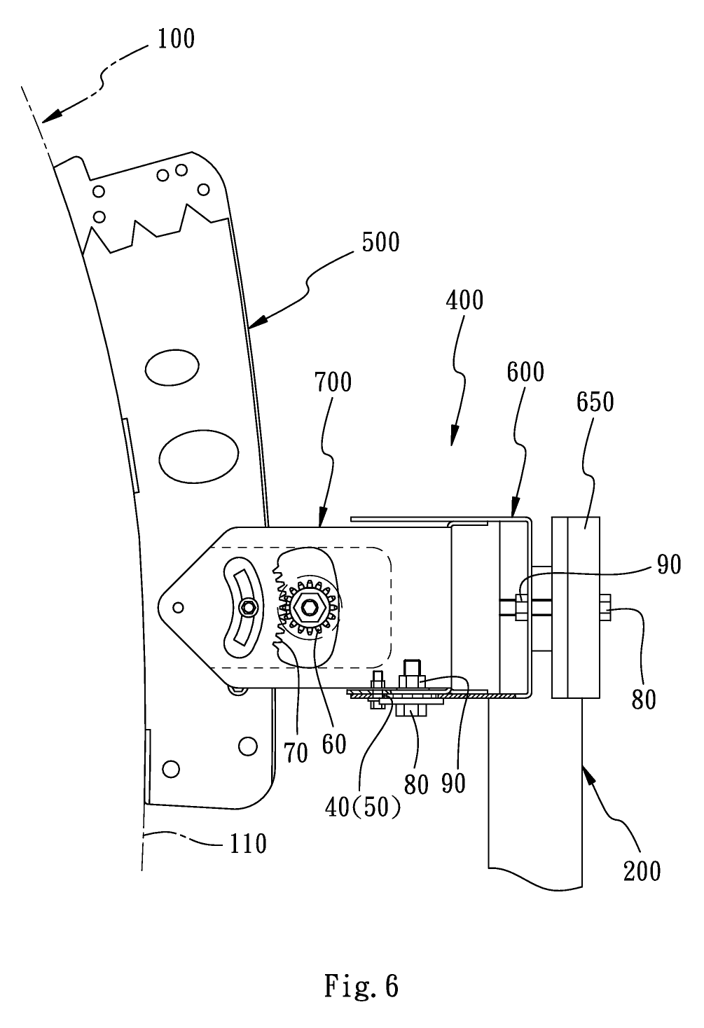

Referring to FIG. 6, a second embodiment of the present adjusting apparatus for the satellite antenna is for connecting between a satellite antenna 100 and an antenna support 200. The adjusting apparatus 400 includes a dish support 500, a supporting base 600, a connecting base 700, a first gear 40, a first row teeth 50, a second gear 60, a second row teeth 70, a plurality of screw bolts 80 and a plurality of screw caps 90.

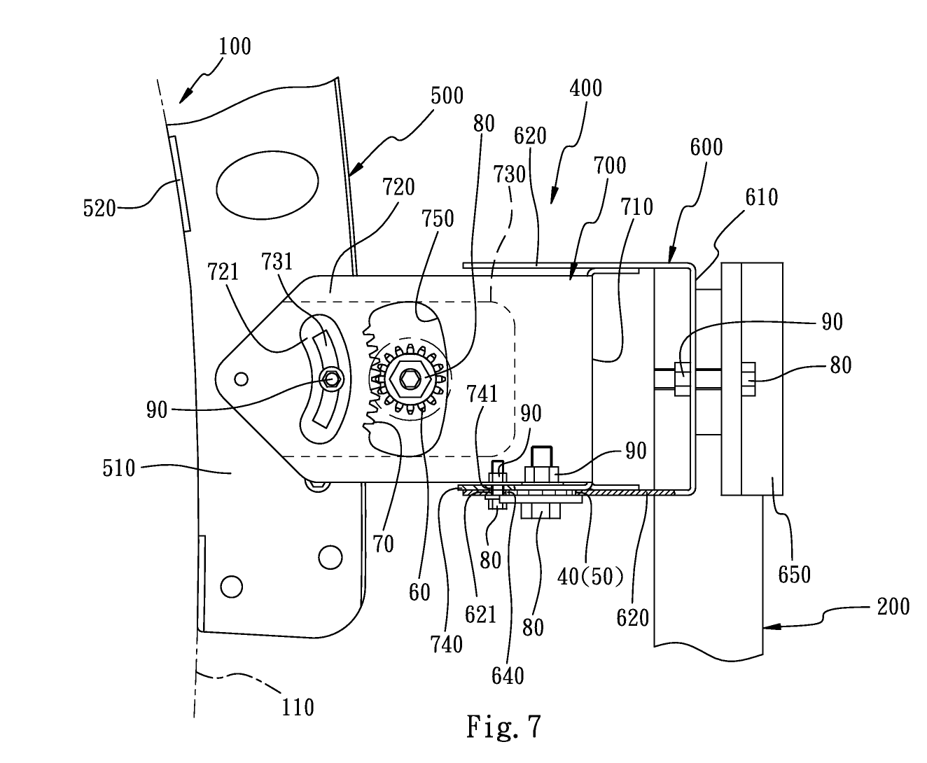

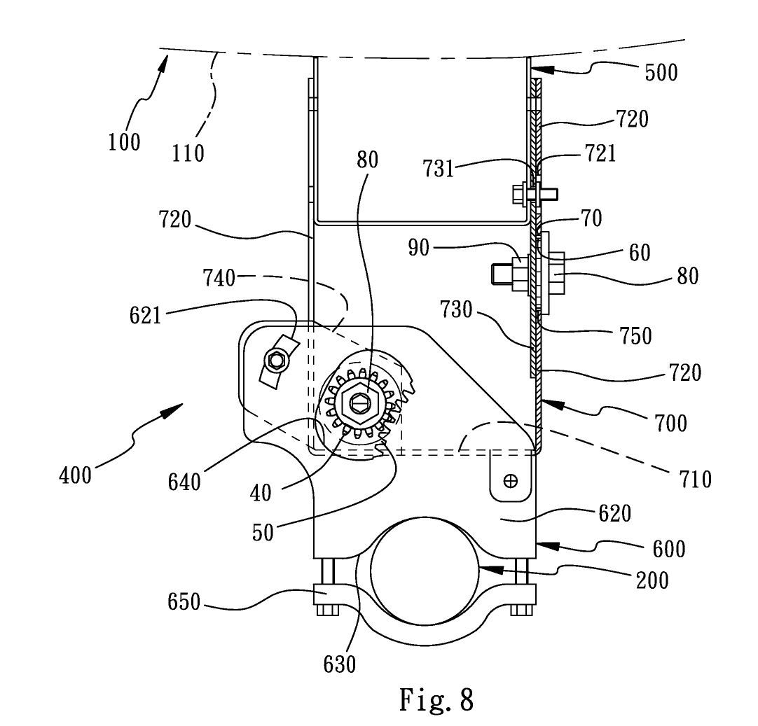

Referring to FIGS. 7 and 8, the dish support 500 includes a main base 510 and a plurality of lugs 520. The lugs 520 are locked to the dish 110 of the satellite antenna 100.

The supporting base 600 includes a bottom wall 610, two sidewalls 620, an indent portion 630, and a fine adjusting hole 640 disposed on one of the sidewalls 620. The indent portion 630 being assisted by a clip 650, together with the screw bolts 80 and the screw caps 90 are clasped and abut on the antenna support 200.

The connecting base 700 includes a bottom wall 710, two sidewalls 720, an inner lining plate 730, an outer lining plate 740, and an adjusting hole 750 disposed on one of the sidewalls 720.

The first gear 40 and the first row teeth 50 cooperatively compose of the fine adjusting mechanism along X-direction. The first row teeth 50 is disposed at the periphery of the fine adjusting hole 640 of the supporting base 600, while the first gear 40 is received in the fine adjusting hole 640 and pivoted on the outer lining plate 740 of the connecting base 700. The first row teeth 50 is in an arc shape, the sidewall 620 of the supporting base 600 has an arced elongate slot 621, the outer lining plate 740 of the connecting base 700 has a locking hole 741 corresponding to the elongate slot 621, and is locked to the connecting base 700 by the screw bolts 80 and the screw caps 90. The elongate slot 621 is configured to match the curve of the first row teeth 50.

The second gear 60 and the second row teeth 70 cooperatively compose of the fine adjusting mechanism along Y-direction. The second row teeth 70 is disposed at the periphery of the fine adjusting hole 750 of the connecting base 700, while the second gear 60 is received in the fine adjusting hole 750 and pivoted on the inner lining plate 730 of the connecting base 700. The second row teeth 70 is in an arc shape, the sidewall 720 of the connecting base 700 has an arced elongate slot 721, the inner lining plate 730 of the connecting base 700 has a locking hole 731 corresponding to the elongate slot 721. The connecting base 700 is locked to the dish support 500 by the screw bolts 80 and the screw caps 90. The elongate slot 721 is configured to match the curve of the second row teeth 70.

From the above descriptions, in the second embodiment of the present adjusting apparatus for the satellite antenna, both of the adjust manners along X and Y directions are using the gear and the row teeth cooperating with the elongate slot to operate synchronous adjustment, so that the satellite antenna 100 obtains the fine adjustment effect along the horizontal and perpendicular directions, for obtaining the accurate fine adjustment effect. To match different parts of the present embodiment, the gear and the row teeth are applied to the elongate and wide-plated adjusting apparatus 400, other functions and usages of the present embodiment are the same as the first embodiment.

Worthy mentioning is, in the above two embodiments, by means of the combination of the first gear and the first row teeth, and the combination of the second gear and the second row teeth respectively obtaining the fine adjustment along the X-direction and the Y-direction, are the best modes of the present invention. Furthermore, because both of the connecting base and the supporting base have two sidewalls, arranging two groups of the first gear and the first row teeth, and two groups of the second gear and the second row teeth on the above sidewalls can also obtain the prospective efficacy.

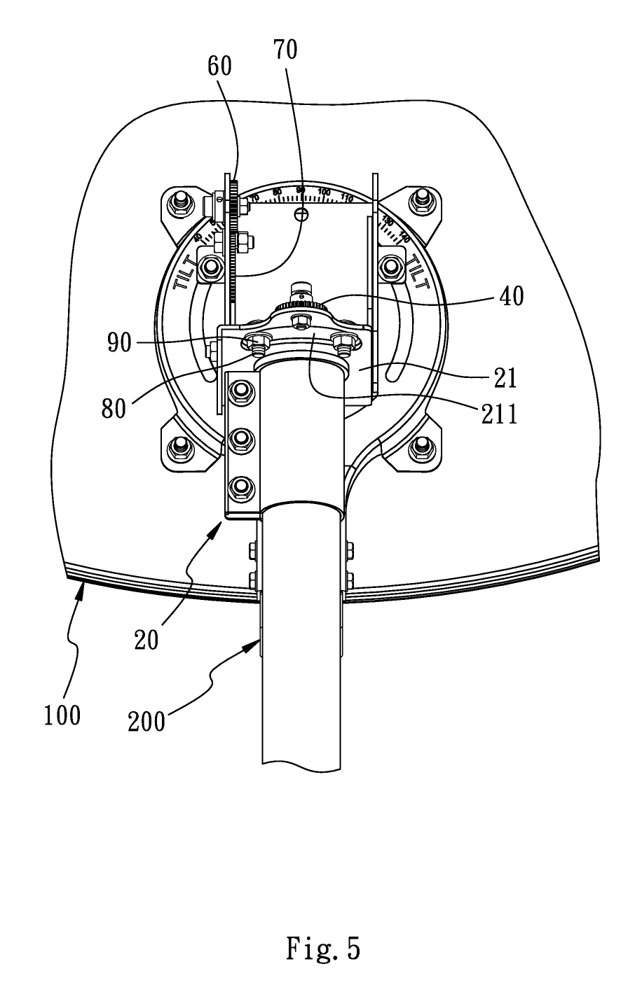

Referring to FIG. 5, a plurality of indicating lines can also be disposed on the dish support 10, for indicating the deflecting angles along the X-direction.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An adjusting apparatus for a satellite antenna, for connecting between a satellite antenna and an antenna support, comprising:
a dish support for coupling to a dish of the satellite antenna;
a supporting base coupled to the antenna support;
a connecting base connected between the dish support and the supporting base;
an X-direction fine adjusting mechanism comprising at least a group composed by a gear and a row teeth, and being coupled between the supporting base and the connecting base, by means of the meshing relation between the gear and the row teeth, connecting the dish support, inducing the satellite antenna, relative to the antenna support, generate a tiny range of motions along X-direction; and
a Y-direction fine adjusting mechanism comprising at least a group composed by a gear and a row teeth, and being coupled between the connecting base and the dish support, by means of the meshing relation between the gear and the row teeth, connecting the connecting base and the dish support, inducing the satellite antenna, relative to the antenna support, generate a tiny range of motions along Y-direction.

2. The adjusting apparatus as claimed in claim 1, wherein the dish support includes a bottom bracket, a clawed fixing bracket and a coupling bracket, the fixing bracket being coupled to the dish of the satellite antenna, the bottom bracket outwardly extending from the fixing bracket, inducing the peripheral fringe of the satellite antenna abut against the bottom bracket, the coupling bracket extending from the fixing bracket toward a direction remote from the dish of the satellite antenna; the supporting base including a supporting dish and a socket pipe, the socket pipe being connected to the antenna support, the supporting dish being arranged on the socket pipe; the connecting base including a bottom wall and two sidewalls; the X-direction fine adjusting mechanism including a first gear and a first row teeth meshed with the first gear, the first gear being pivoted on the supporting dish of the supporting base, the first row teeth being disposed on the side end surface of the bottom wall of the connecting base; the Y-direction fine adjusting mechanism including a second gear and a second row teeth meshed with the second gear, the second gear being pivoted on the coupling bracket of the dish support, the second row teeth being disposed on the side end surface of the sidewall of the connecting base.

3. The adjusting apparatus as claimed in claim 2, wherein the first row teeth is in an arc shape, the supporting dish of the supporting base having an arced elongate slot, the elongate slot being configured to match the curve of the first row teeth.

4. The adjusting apparatus as claimed in claim 2, wherein the second row teeth is in an arc shape, the coupling bracket of the dish support having an arced elongate slot, the elongate slot being configured to match the curve of the second row teeth.

5. The adjusting apparatus as claimed in claim 2, wherein a group of screw bolts and screw caps are disposed through the coupling bracket and the sidewalls of the connecting base, and the screw bolts just locates in the elongate slot of the coupling bracket, the connecting base being locked to the coupling bracket of the dish support by the screw bolts and the screw caps.

6. The adjusting apparatus as claimed in claim 2, further comprising a screw bolt and a screw cap, the screw bolt and the screw cap locking the supporting base to the connecting base.

7. The adjusting apparatus as claimed in claim 1, wherein the dish support includes a main base and a plurality of lugs, the lugs being locked to the dish of the satellite antenna, the supporting base including a bottom wall, two sidewalls, an indent portion, and at least a fine adjusting hole disposed on at least one of the sidewalls, the indent portion being clasped and abutting on the antenna support; the connecting base including a bottom wall, two sidewalls, an inner lining plate, an outer lining plate, and at least an adjusting hole disposed on at least one of the sidewalls; the X-direction fine adjusting mechanism including a first gear and a first row teeth meshed with the first gear, the first row teeth being disposed at the periphery of the fine adjusting hole of the supporting base, the first gear being received in the fine adjusting hole and pivoted on the outer lining plate of the connecting base; the Y-direction fine adjusting mechanism including a second gear and a second row teeth meshed with the second gear, the second row teeth being disposed at the periphery of the adjusting hole of the connecting base, the second gear being received in the adjusting hole and pivoted on the inner lining plate of the connecting base.

8. The adjusting apparatus as claimed in claim 7, wherein the first row teeth is in an arc shape, the sidewall of the supporting base having an arced elongate slot, the outer lining plate of the connecting base having a locking hole corresponding to the elongate slot, and being locked to the connecting base, the elongate slot being configured to match the curve of the first row teeth.

9. The adjusting apparatus as claimed in claim 7, wherein the second row teeth is in an arc shape, the sidewall of the connecting base having an arced elongate slot, the inner lining plate of the connecting base having a locking hole corresponding to the elongate slot, and being locked to the dish support, the elongate slot and the locking hole being configured to match the curve of the second row teeth.

10. The adjusting apparatus as claimed in claim 8, wherein the elongate slot of the supporting base corresponds to the locking hole of the outer lining plate, the supporting base being locked to the connecting base by the screw bolts and the screw caps.

11. The adjusting apparatus as claimed in claim 9, wherein the elongate slot of the connecting base corresponds to the locking hole of the inner lining plate, the connecting base being locked to the dish support by the screw bolts and the screw caps.
